(19) United States
(12) Patent Application Publication
(10) Pub. No.: US 2013/0107537 A1
(43) Pub. Date: May 2, 2013

(54) ROTATING DEVICE TO CHANGE LIGHTING ANGLE

(71) Applicants: Chien-Kuo Lee, Pingzhen City (TW); Ching-Tai Lu, Pingzhen City (TW); Po-Cheng Huang, Pingzhen City (TW); Yi-Cheng Su, Pingzhen City (TW)

(72) Inventors: Chien-Kuo Lee, Pingzhen City (TW); Ching-Tai Lu, Pingzhen City (TW); Po-Cheng Huang, Pingzhen City (TW); Yi-Cheng Su, Pingzhen City (TW)

(21) Appl. No.: 13/286,618

(22) Filed: Nov. 1, 2011

(51) Int. Cl. F21V 21/14

(52) U.S. Cl. 362/283

(57) ABSTRACT

A lamp rotating device to change a lighting angle includes a light tube, a lighting module, two fixed ends and two rotating parts, an open is on both ends of the light tube, two fixed ends each is installed on one open, each of the rotating part is installed between the fixed end and the open respectively, one side of the rotating part interferes with light tube to have the light tube rotate along the fixed end by the movements of rotating part, and change a lighting angle.

### BACKGROUND OF THE INVENTION

1. Field of the Invention

The present invention relates to a lamp rotating device thereof, in particular to a lamp rotating device to change lighting angle thereof.

2. Description of the Related Art

Heretofore, it is known that Light Emitting Diode LED is a solid state semiconductor component, by means of current passes through diode to convert electrical energy into lighting. LED has advantages as small volume, light weight, rapid reaction speed and no pollution, that makes LED application gradually expands to all industry. Initially LED faced insufficient brightness and low lighting efficiency bottlenecks, but high power LED developed afterwards solved insufficient brightness problem, LED gradually steps into high efficiency lighting source market, and gradually replaces traditional tungsten lamps, is a potential product in the future to replace traditional lighting products.

However, general consumers still use traditional lamps, therefore in a short period of time, if traditional lamps are not fully out of order, most of consumers will not changes to new LED lamps soon. Since the widely used traditional lamp still need a lamp holder, the lamp holders can last very long without damage compare to lamp itself, traditional lamp is an consumable product, damages sometimes later (about 1 years) and must be replaced.

For the condition mentioned, related industries developed a LED lamp holder, consumers can install LED lamp directly on the traditional lamp holder to achieve no need to obsolete conventional lamp holders, save resources and enjoy the benefit of LED lamp.

However, under current lamp specifications, to use light emitting diode (LED) as the light source, although the existing power supply plug is still available, but it cannot change or adjust lighting angle which cannot meet users' demand and causes inconvenience.

### SUMMARY OF THE INVENTION

In view of the aforementioned problems of the prior art, it is a primary objective of the present invention to provide a lamp rotating device to change lighting angle therefore.

To achieve the foregoing objective, the present invention provides lamp rotating device to change lighting angle comprising: a light tube, a lighting module, two fixed ends and two rotating parts; an open is on both ends of the light tube. The lighting module is installed inside the light tube, each fixed end is fixed on the open of the light tube respectively, each of the rotating part is installed between the fixed end and the open respectively; one side of the rotating part interferes with light tube to have the light tube rotate along the fixed end by the movements of rotating part, and achieve a lighting angle changeable device with simple structure and sturdy combination.

### BRIEF DESCRIPTION OF THE DRAWINGS

FIG. 1 is an assembly view of a lamp rotating device to change lighting angle in accordance with the first preferred embodiment of the present invention;

FIG. 2 is a perspective view of a lamp rotating device to change lighting angle in accordance with the first preferred embodiment of the present invention;

FIG. 3 is another perspective view of a lamp rotating device to change lighting angle in accordance with the first preferred embodiment of the present invention;

FIG. 4 is an assembly view of a lamp rotating device to change lighting angle in accordance with the second preferred embodiment of the present invention;

FIG. 5 is a cross-sectional view of a lamp rotating device to change lighting angle in accordance with the second preferred embodiment of the present invention;

FIG. 6 is a perspective view of a lamp rotating device to change lighting angle in accordance with the second preferred embodiment of the present invention;

FIG. 7 is another perspective view of a lamp rotating device to change lighting angle in accordance with the second preferred embodiment of the present invention;

FIG. 8 is an assembly view of a lamp rotating device to change lighting angle in accordance with the third preferred embodiment of the present invention;

FIG. 9 is a cross-sectional view of a lamp rotating device to change lighting angle in accordance with the third preferred embodiment of the present invention;

FIG. 10 is a perspective view of a lamp rotating device to change lighting angle in accordance with the third preferred embodiment of the present invention;

FIG. 11 is another perspective view of a lamp rotating device to change lighting angle in accordance with the third preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

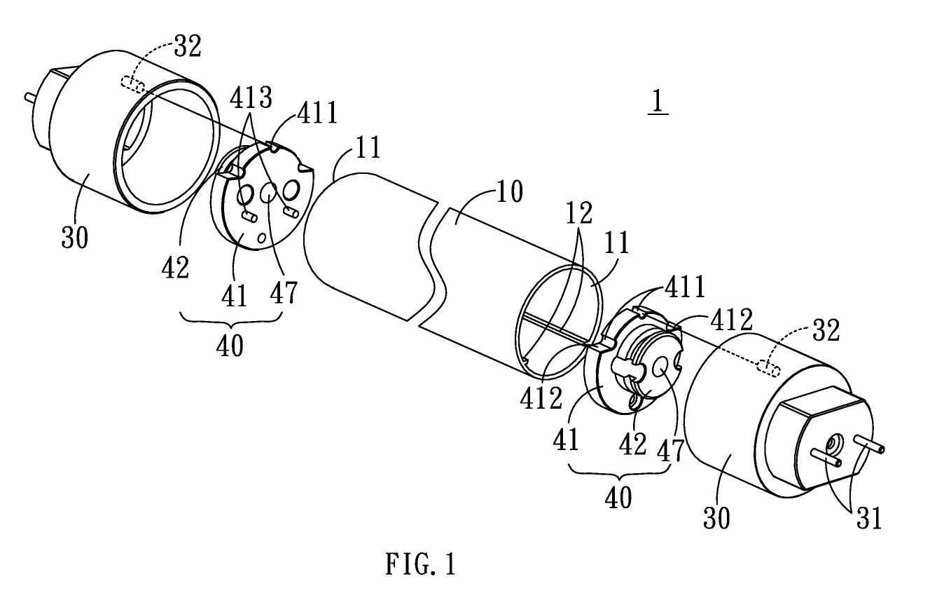

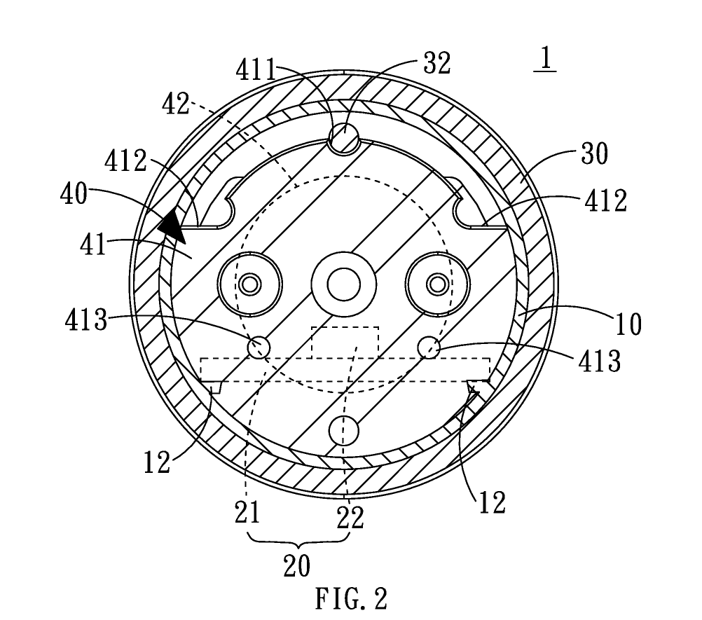

Refer to FIG. 1, an assembly view of a lamp rotating device to change lighting angle in accordance with the first preferred embodiment of the present invention, and FIG. 2 a perspective view of a lamp rotating device to change lighting angle in accordance with the first preferred embodiment of the present invention. The present invention comprises a light tube 10, a lighting module 20, two fixed ends 30 and two rotating parts 40.

The light tube 10 is made of light penetrable material in a hollow tube structure, an open 11 is on both ends of the light tube 10, and two convex stems 12 are formed inside the light tube 10.

The lighting module 20 consists of a circuit board 21 with a plurality number of LED's 22 on board, the lighting module 20 is installed inside the light tube 10, and circuit board 21 is fixed on top of the convex stems 12.

Two fixed ends 30 each is fixed on the open 11 of the light tube 10 respectively, two conductive tips 31 are on the end of each fixed end 30.

Each of the rotating part 40 is installed between the fixed end 30 and the open 11 respectively, as shown in figures; a tooth board 41 and a pivot 42 are installed on the rotating parts 40, a plurality number of concave slots 411 are on the rim of the tooth board 41, the positioning rods 413 corresponding to top of the convex stems 12 are on one side of the tooth board 41 towards the open 11, the circuit board 21 is installed between the convex stems 12 and the positioning rods 413 to introduce mutual interference between the tooth board 41 and the light tube 10; the pivot 42 is on another side of the tooth board 41 and connects to the fixed end 30; a positioning piece 32 is inside the fixed end 30 and gears into the corresponding concave slot 411, at least one through hole 47 is on the tooth board 41 and the pivot 42 to connect conductive tips 31 and circuit board 21 inside the light tube 10 (not shown in Fig.).

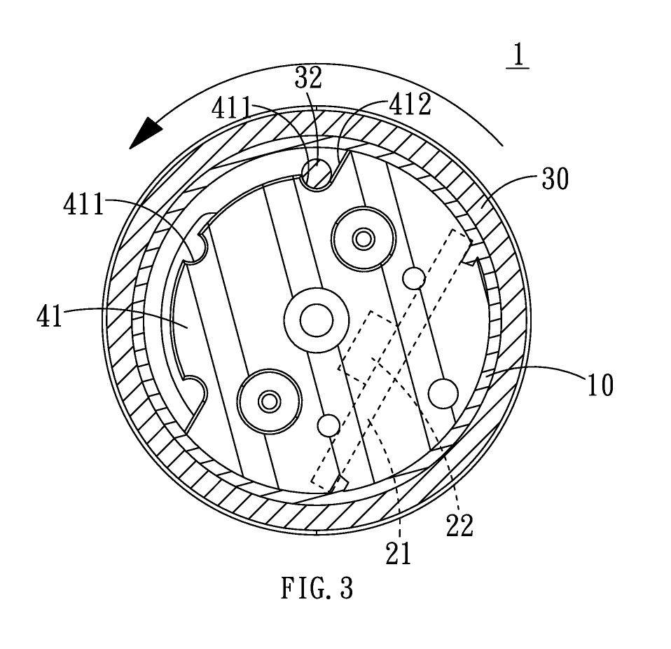

The first preferred embodiment is fixed on a regular lampholder by two fixed ends 30 (not shown in Fig.); users rotate the light tube 10 to adjust lighting angle, the light tube 10 rotates along the pivots 42 on both ends, the tooth boards 41 rotate simultaneously, the positioning pieces 32 on two ends rotate from original position of the tooth board 41 to the corresponding concave slots 411; when position pieces 32 are in the corresponding concave slots 411, as shown in FIG. 3, the light tube 10 is on the corresponding angle. Users can base on real need, by rotating light tube 10 to turn corresponding rotating parts 40 to adjust the light tube 10 for the best lighting angle.

Furthermore, each tooth board 41 has two stoppers 412, when the light tube 10 rotates, the tooth boards 41 on two ends rotate simultaneously, when positioning piece 32 touches one of the stopper 412, the stopper 412 keeps the light tube 10 from turning to prevent users from over rotate the light tube 10 as a result of excessive rotation to damage the device.

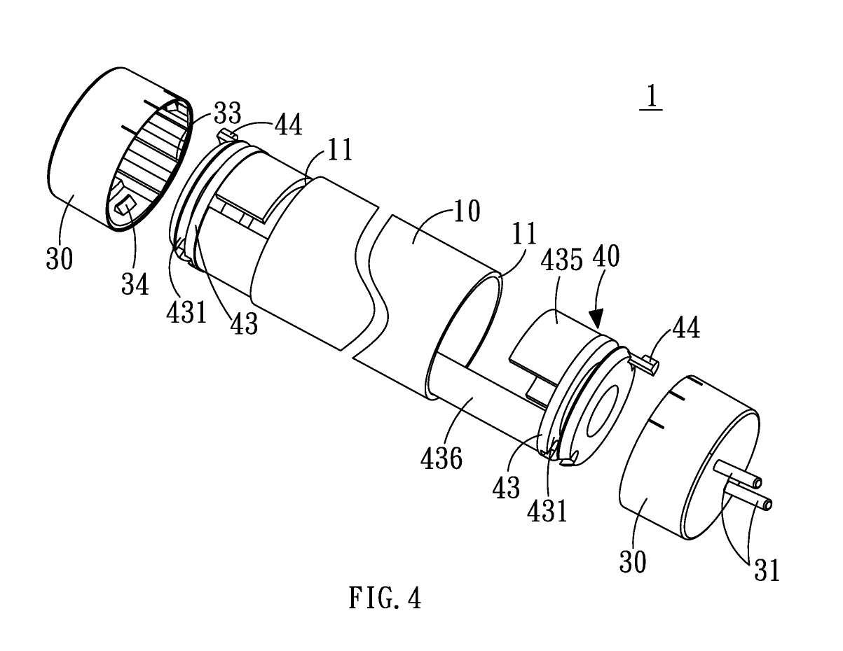

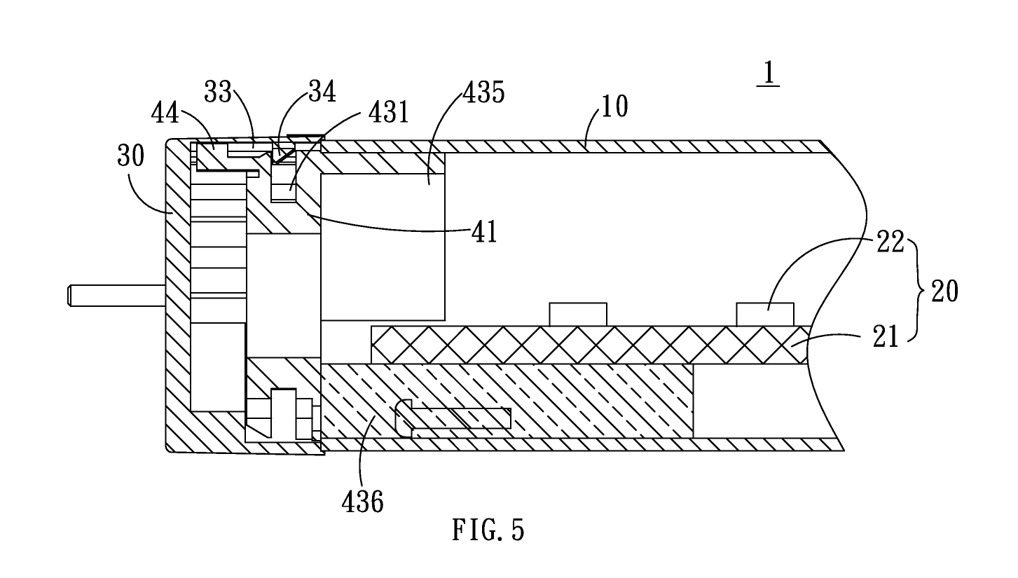

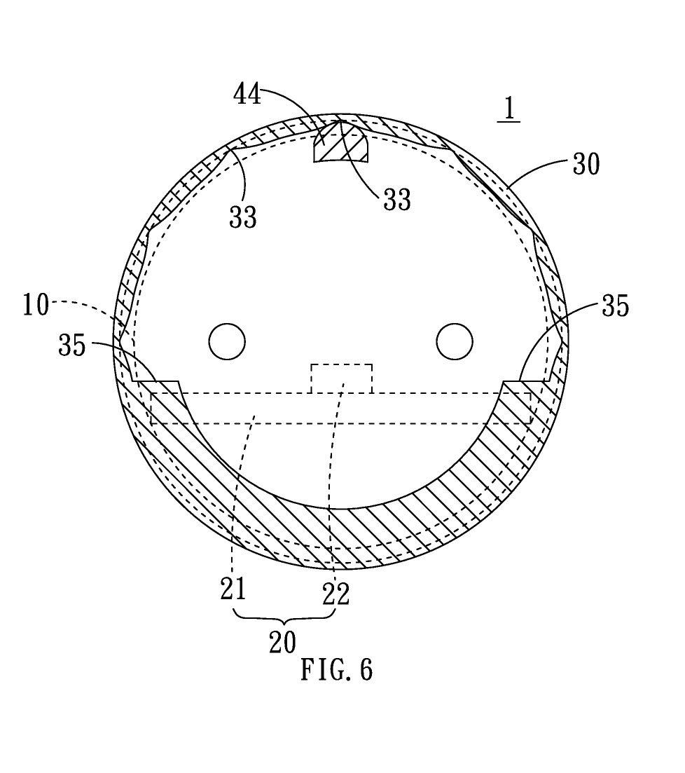

With reference from FIG. 4 to FIG. 6, different views of a lamp rotating device to change lighting angle in accordance with the second preferred embodiment of the present invention. The rotation part 40 consists of a main body 43 and a guidance 44; an upper curve 435 and a lower curve 436 matching the shape of the open 11 are formed on one side of the main body 43, a gap is between upper and lower curve 435, 436 to place the circuit board 21 for mutual interference between the main body 43 and light tube 10; the guidance 44 locates on the other side of the main body 43; a plurality number of guidance slots 33 are on the inner side of the fixed end 30, the guidance 44 gears into the guidance slots 33 of the fixed ends 30; a ring slot 431 is on the main body 43, at least one brake 34 is on the inner side of the fixed ends 30, the brake 34 can also be installed inside the ring slot 431; a plurality number of brakes 34 can be installed in a ring path.

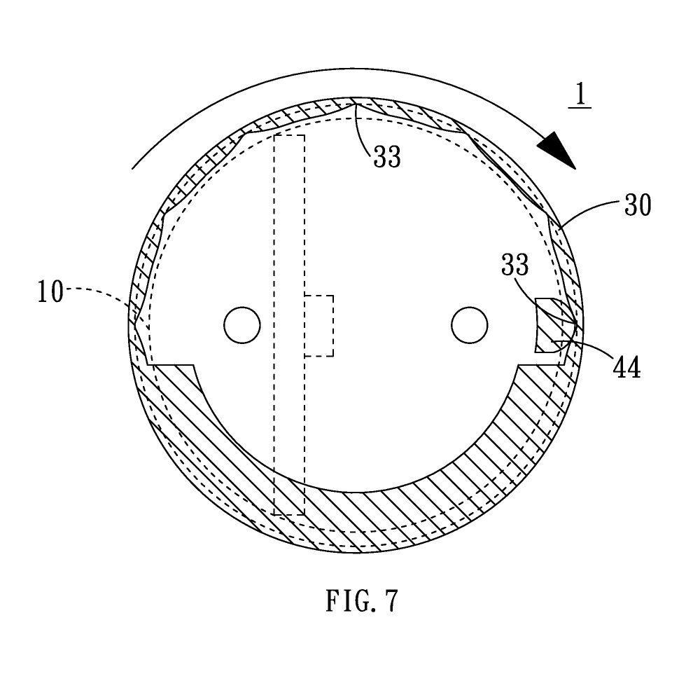

The second embodiment is fixed on a regular lamp holder by two fixed ends 30 (not shown in Fig.); users rotate the light tube 10 to adjust lighting angle, the light tube 10 rotates on the brakes 34 of the ring slots 431 on both ends, the main bodies 43 on both ends rotate simultaneously, the guidances 44 on two ends rotate from the original guidance slot 33 to other corresponding guidance slot 33, as shown in FIG. 7; the light tube 10 is on the corresponding angle. Users can base on real need, by rotating light tube 10 to turn corresponding rotating parts 40 to adjust the light tube 10 for the best lighting angle.

Furthermore, each fixed end 30 has two stoppers 35, when the light tube 10 rotates, the guidances 44 on two ends rotate simultaneously, when the guidances 44 touch one of the stopper 35, the stopper 35 keeps the light tube 10 from turning to prevent users from over rotate the light tube 10 as a result of excessive rotation to damage the device.

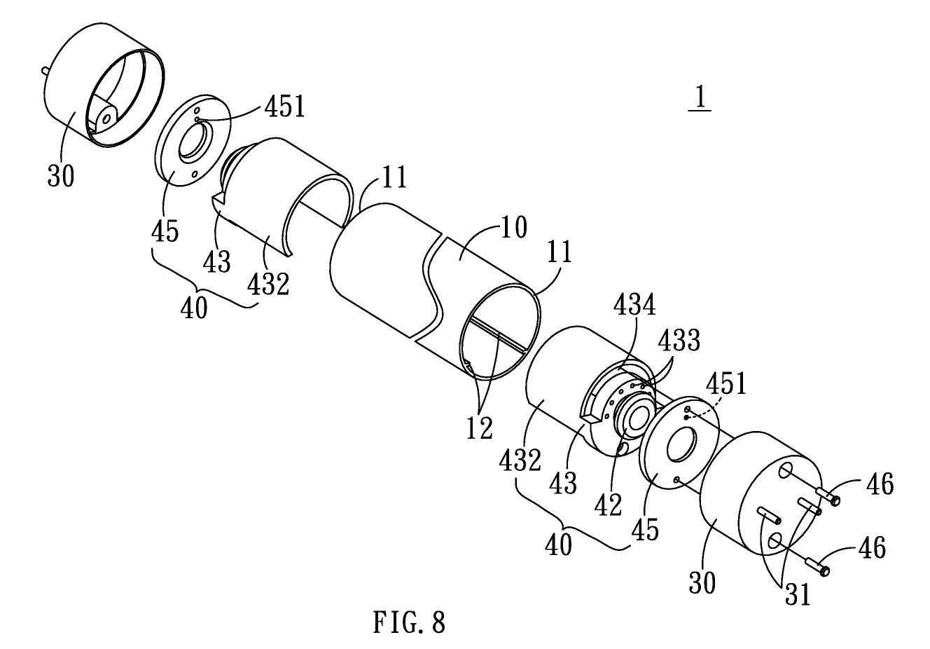

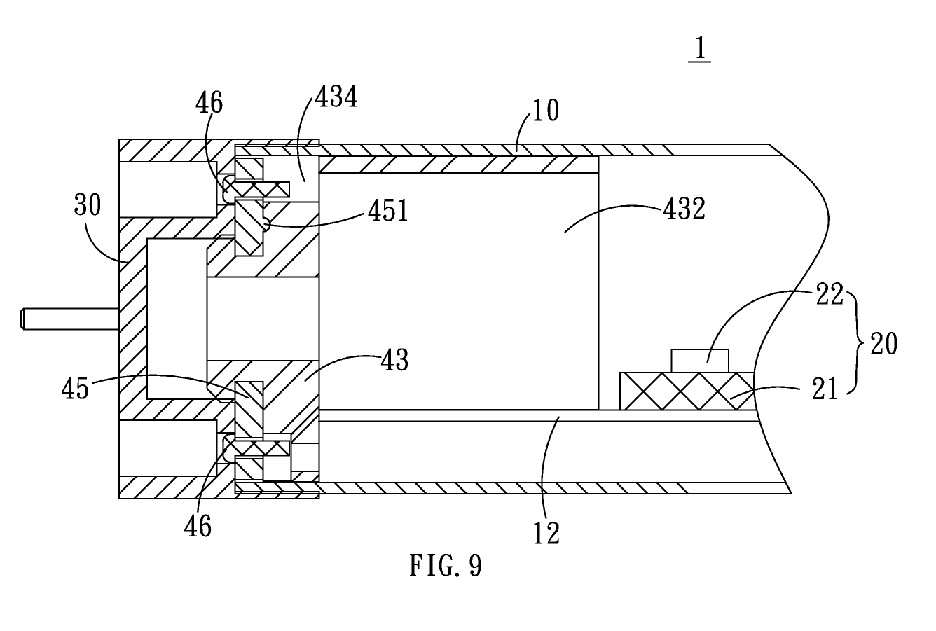

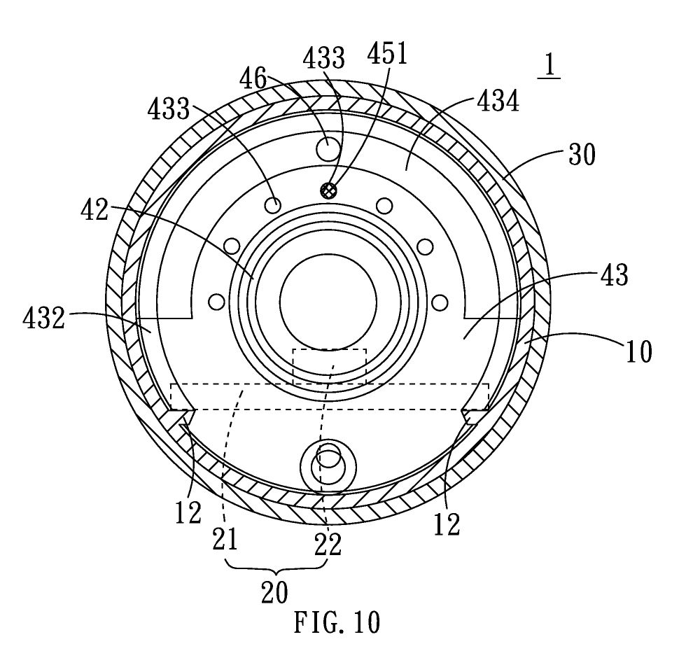

With reference from FIG. 8 to FIG. 10, different views of a lamp rotating device to change lighting angle in accordance with the third preferred embodiment of the present invention. The rotation part 40 consists of a main body 43, a pivot 42 and a plate 45; a curve 43 matching the shape of the open 11 is on one side of the main body 43; two convex stems 12 are formed inside the light tube 10, when the curve 432 is inserted into the open, it is stopped on top of two convex stems 12 which causes mutual interference of the bodies 43 and the light tube 10; the pivot 42 locates on the other side of the body 43 to connect to the plate 45, the plate 45 is fastened on inner side of the fixed end 30 by at least one fastener 46; corresponding convexes and concaves are between the main bodies 43 and plates 45. In the third preferred embodiment, a plurality number of concaves 433 in round shape are on the main bodies 43, corresponding convexes 451 are on the plates 45.

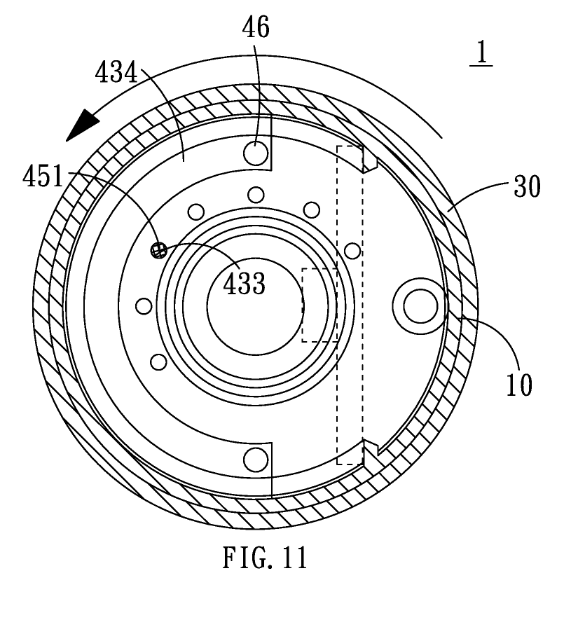

The third embodiment is fixed on a regular lamp holder by two fixed ends 30 (not shown in Fig.); users rotate the light tube 10 to adjust lighting angle, the light tube 10 rotates along the pivots 42 on both ends, the main bodies 43 on both ends rotate simultaneously, the convexes 451 turn from the original concave 433 original locations to other corresponding concave 433 locations; when convexes 451 on the new corresponding concave 433 locations, as shown in FIG. 11, the light tube 10 is on the corresponding angle. Users can base on real need, by rotating light tube 10 to turn corresponding rotating parts 40 to adjust the light tube 10 for the best lighting angle. A plurality number of concaves 433 can be on the plates 45 and corresponding convexes 451 are on the main bodies 43 for the same effect.

Furthermore, a curve slot 434 is on the main body 43 facing the plate 45 to have the fasteners 46 lock the plate 45 from outside of the fixed end 30; the end of the fastener 46 passes through the curve slot 434, when the light tube 10 keeps rotating, the curve slot 434 turns along with the main body 43, when fasteners 46 reach one end of the curve slot 434, it can stop the light tube 10 from rotating to prevent users from over rotate the light tube 10 as a result of excessive rotation to damage the device.

While a preferred embodiment of the invention has been shown and described in detail, it will be readily understood and appreciated that numerous omissions, changes and additions may be made without departing from the spirit and scope of the invention.

What is claimed is:

1. A lamp rotating device to change lighting angle comprising:
a light tube is made of light penetrable material in a hollow tube structure, an open is on both ends of said light tube;
a lighting module consists of a circuit board with a plurality number of LED's on board, said lighting module is installed inside said light tube;
two fixed ends each is fixed on said open of said light tube respectively, a plurality number of guidance slots are installed inside said fix end;
two rotating part each is installed between said fixed end and said open respectively, each of said rotation part consists of a main body and a guidance, one side of said main body interferes with said open of said light tube, said guidance is on the other side of said main body, said guidance gears into the guidance slots of said fixed ends to have said light tube rotate along with said fixed end by the movements of said rotating part.

2. The lamp rotating device to change lighting angle of claim 1, wherein a ring slot is on said main body, at least one brake is on the inner side of said fixed ends, said brake can also be installed inside said ring slot.

3. The lamp rotating device to change lighting angle of claim 1, wherein a plurality number of said brakes are installed in a ring path.

4. The lamp rotating device to change lighting angle of claim 1, wherein two stoppers are installed inside of said fixed ends.

5. The lamp rotating device to change lighting angle of claim 1, wherein an upper curve and a lower curve matching the shape of said open are on one side of said main body, a gap is between said upper and lower curve to place said circuit board.

6. The lamp rotating device to change lighting angle of claim 1, wherein two conductive tips are on the end of each said fixed end, at least one through hole is on said rotating parts to connect conductive tips and said circuit board inside said light tube.
